(19) United States
(12) Patent Application Publication
(10) Pub. No.: US 2001/0016862 A1
(43) Pub. Date: Aug. 23, 2001

(54) Parallel random pattern generator circuit and scramble circuit and descramble circuit using the same

(76) Inventors: Yasuo Saito, Miyagi (JP); Masahiro Yazaki, Tokyo (JP)

Correspondence Address: SUGHRUE, MION, ZINN, MACPEAK & SEAS, 2100 Pennsylvania Avenue, N.W., Washington, DC, 20037-3202, US

(21) Appl. No.: 09/788,563

(22) Filed: Feb. 21, 2001

(30) Foreign Application Priority Data
Feb. 23, 2000 (JP) 2000-045297

(51) Int. Cl. G06F 1/02; G06F 7/58

(52) U.S. Cl. 708/252; 708/253

(57) ABSTRACT

An n-bit parallel random pattern generation circuit comprises: an m-bit register having an m-bit input and an m-bit output; a pattern generation means having an m-bit input and an (n+m)-bit output with the input bits 1 through m thereof connected with the output bits 1 through m, respectively, of said m-bit register, said pattern generation means operating an (n+m)-bit parallel pattern having bits 1 through n+m in accordance with a predetermined combination rule that defines a way of logically combining the individual m input bits thereof; and feedback means for feeding-back the bits (n+1) through (n+m) of said (n+m)-bit parallel pattern to said m-bit input of said m-bit register, wherein the bits 1 through n of said (n+m)-bit parallel pattern are supplied as an n-bit parallel random pattern.

### BACKGROUND OF THE INVENTION

The present invention relates to a parallel random pattern generator circuit and also to a scramble and a descramble circuit using the parallel random pattern generator circuit. In particular, the present invention relates to a system for generating an n-bit parallel random pattern associated with a generator polynomial X^{m}+X^{p}+1 (m and p are natural numbers satisfying an inequality m>p) for using an n (a natural number) bit parallel scramble processing.

FIG. 1 shows an example of a random pattern generator circuit that has been commonly used for generating the scramble pattern associated with the above-described generator polynomial.

Referring to the figure, the circuit is configured with cascaded seven flip-flop circuits 21-27: the Q-outputs of the sixth and seventh flip-flops are fed to the inputs of EX.OR 28 the output of which is fed back to the D-input of first-stage flip-flop 21; and the Q-output of the seventh flip-flop 27, the last stage flip-flop, is taken out as a random pattern for scrambling.

A scramble initialization signal is supplied to an S-input of each flip-flop to initialize the scrambling. The scramble initialization signal causes the outputs of flip-flops 21-27 to be set to “1111111”. The flip-flop 27 provides, as an output, a serial scramble pattern of a 27=128 bit period in synchronization with a clock input, as is shown in FIG. 2.

In a communication system in compliance with the SDH (Synchronous Digital Hierarchy), it is necessary to operate the scrambler circuit at 9953 MHz when the scrambler circuit as shown in FIG. 1 is employed for signal processing in accordance with STM (Synchronous Transfer Module)-64 (9953 Mbps). Such an operation, however, is quite difficult for an ordinary CMOS-IC to perform. For this reason, a scrambler circuit has been required which is capable of performing signal processing with ease in accordance with STM-64 using a CMOS-IC.

The present invention has been made in view of the above-described requirement. The present invention is intended to provide a random pattern generator circuit capable of meeting the above requirement even if a CMOS-IC of a low operation speed is employed. The present invention is further intended to provide a parallel scramble circuit and a descramble circuit in which the parallel random pattern generator circuit is employed.

### SUMMARY OF THE INVENTION

The intention of the present invention can be realized by generating an n (a natural number) bit parallel random pattern and effecting concurrent parallel processing of the n-bits of the random pattern.

An n-bit parallel random pattern generation circuit comprises: an m-bit register having an m-bit input and an m-bit output; a pattern generation means having an m-bit input and an (n+m)-bit output with the input bits 1 through m thereof connected with the output bits 1 through m, respectively, of said m-bit register, said pattern generation means operating an (n+m)-bit parallel pattern having bits 1 through n+m in accordance with a predetermined combination rule that defines a way of logically combining the individual m input bits thereof; and feedback means for feeding-back the bits (n+1) through (n+m) of said (n+m)-bit parallel pattern to said m-bit input of said m-bit register, wherein the bits 1 through n of said (n+m)-bit parallel pattern are supplied as an n-bit parallel random pattern.

The pattern generation means is provided with an exclusive OR means for generating a parallel pattern by allotting the m input bits 1 through m to the first m bits 1 through m of the parallel pattern as is and generating the following n bits (m+1) through (m+n) in such a way that an Ex.OR of the bit i and the bit (i+1) makes the bit (m+i) of the parallel pattern, wherein said first n bits of the (n+m)-bit parallel pattern are supplied as the n-bit parallel random pattern and the following m bits of the (n+m)-bit parallel pattern are fed back by way of the feedback means.

The feedback means includes OR gates for performing an OR operation of both an initialization signal for initializing the n-bit parallel random pattern generation circuit and each of the bits (n+1) through (n+m) of the (n+m)-bit parallel pattern.

An n-bit parallel scramble circuit of the present invention is directed to scrambling an n-bit parallel input by generating a scramble pattern based on a generator polynomial X^{m}+X^{p}+1, wherein n is a natural number and m and p are natural numbers that satisfy an inequality m>p. The scramble circuit comprises: an m-bit register having an m-bit input and an m-bit output; a pattern generation means having an m-bit input and an (n+m)-bit output with the input bits 1 through m thereof connected with the output bits 1 through m, respectively, of the m-bit register, the pattern generation means operating an (n+m)-bit parallel pattern having bits 1 through n+m in accordance with a predetermined combination rule that defines a way of logically combining the individual m input bits of said pattern generation means; and feedback means for feeding-back the bits (n+1) through (n+m) of said (n+m)-bit parallel pattern to the m-bit input of the m-bit register, wherein the output bits 1 through n of said (n+m)-bit parallel pattern are supplied as an n-bit parallel scramble pattern.

The pattern generation means is provided with a first exclusive OR means for generating a parallel pattern by allotting the m input bits 1 through m to the first m bits 1 through m of said parallel pattern as is, and generating the following n bits (m+1) through (m+n) in such a way that an Ex.OR of the bit i and the bit (i+1) makes the bit (m+i) of said parallel pattern.

The first n bits of said (n+m)-bit parallel pattern are supplied as the n-bit parallel scramble pattern and the following m bits of the (n+m)-bit parallel pattern are fed back by way of the feedback means.

The feedback means includes OR gates for performing an OR operation of both an initialization signal for initializing said n-bit parallel random pattern generation circuit and each of the bits (n+1) through (n+m) of the (n+m)-bit parallel pattern.

The n-bit parallel random pattern generation circuit further includes a second exclusive OR circuit for performing an exclusive OR operation of the n-bit parallel scramble pattern and the n-bit parallel input to be scrambled. The output of the second exclusive OR circuit is supplied as an n-bit parallel scrambled output.

The n-bit parallel random pattern generation circuit further includes an on/off control means for controlling the on/off of the scramble operation.

The on/off control means can be configured to control the on/off of transmission of said n-bit parallel scramble pattern.

The n-bit parallel descramble circuit according to the present invention is directed to descrambling an n-bit parallel scrambled input by generating a descramble pattern based on a generator polynomial X^{m}+X^{p}+1, wherein n is a natural number and m and p are natural numbers that satisfy an inequality m>p.

The descramble circuit comprises: an m-bit register having an m-bit input and an m-bit output; a pattern generation means having an m-bit input and an (n+m)-bit output with the input bits 1 through m thereof connected with the output bits 1 through m, respectively, of said m-bit register, the pattern generation means operating an (n+m)-bit pattern having bits 1 through n+m in accordance with a predetermined combination rule that defines a way of logically combining the individual m input bits of said pattern generation means; and feedback means for feeding-back the bits (n+1) through (n+m) of the (n+m)bit parallel pattern to the m-bit input of the m-bit register.

The bits 1 through n of said (n+m)-bit parallel pattern are supplied as an n-bit parallel descramble pattern.

Since n bits of the scramble/descramble pattern are generated concurrently and the n-bit parallel pattern allows concurrent scrambling/descrambling of each bit of an n-bit input signal, the present invention allows an employment of an ordinary CMOS-IC for the signal processing in which a high processing velocity is required, for example, for the signal processing in accordance with the STM-64 of an SDH apparatus.

Furthermore, the number of the bits of the m-bit register m is determined from the order of the generator polynomial regardless of the number of the parallel bits. This allows the reduction of the circuit scale as well as the reduction of a power expenditure.

The above and other objects, features and advantages of the present invention will become apparent from the following description referring to the accompanying drawings which illustrate an example of a preferred embodiment of the present invention.

### BRIEF DESCRIPTION OF DRAWINGS

FIG. 1 shows an example of a random pattern generator circuit of prior art;

FIG. 2 shows a scramble pattern of the circuit shown in FIG. 1;

FIG. 3 shows a circuit diagram of a preferred embodiment of the present invention;

FIG. 4 represents a concrete example of an operation of the circuit shown in FIG. 3;

FIG. 5 shows a logical operation rule for the pattern generated by the pattern generation section 7 of the circuit shown in FIG. 3;

FIG. 6 shows a logical operation rule of FIG. 5 expressed in terms of hardware description language; and

FIG. 7 represents a circuit diagram showing the configuration of the present invention in general terms.

### DETAILED EXPLANATION OF THE PREFERRED EMBODIMENT

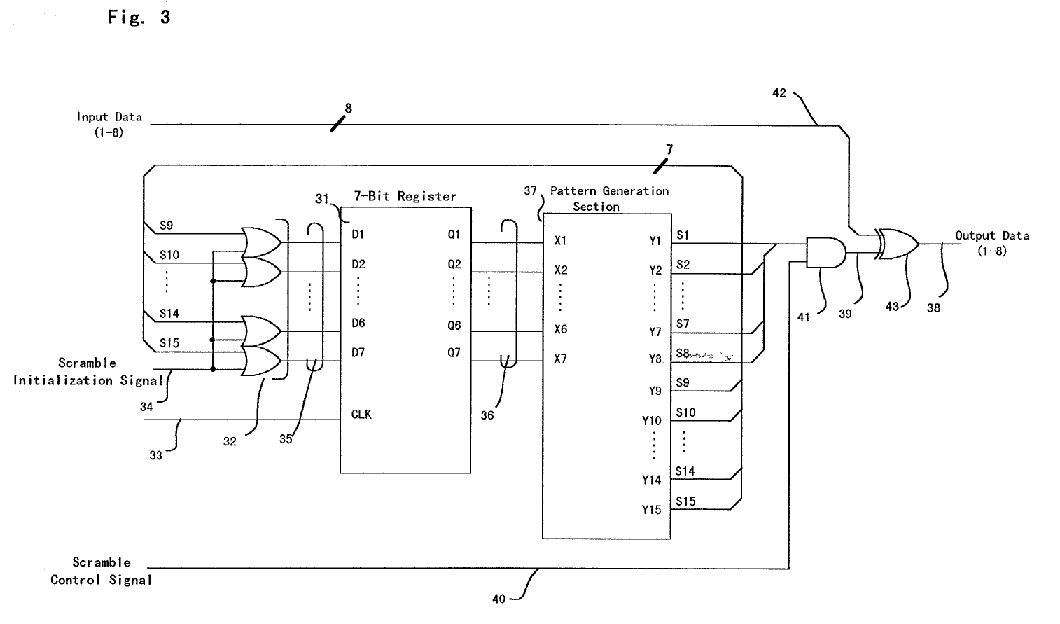

FIG. 3 shows a circuit diagram of a preferred embodiment of the present invention. The circuit is configured to adapt to a scrambler circuit used in a new digital communication network of the SDH. The scrambler is a frame synchronization reset scrambler having a sequence length of 127, the generation polynomial of which is

X⁷+X⁶+1 (1).

It is assumed that the number of parallel bits n is 8 as an example.

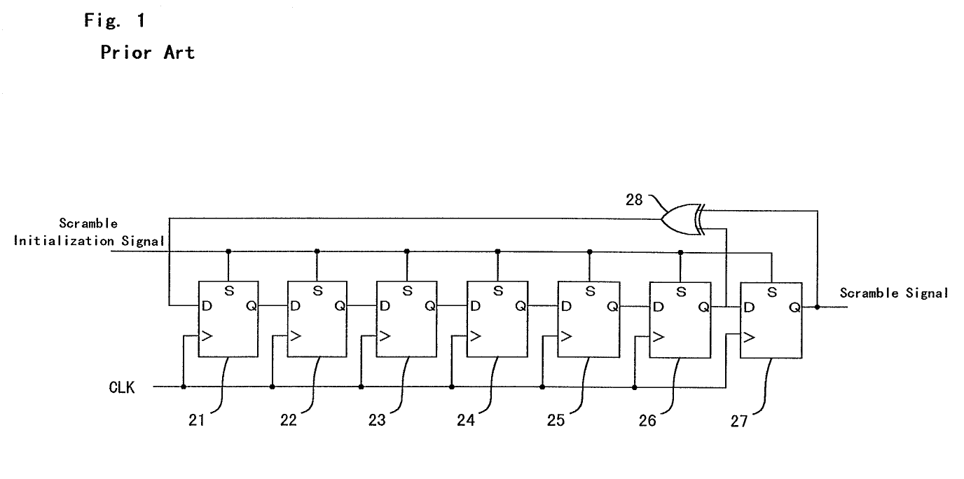

Referring now to FIG. 3, the present circuit comprises 7-bit register 31, pattern generation section 37, OR gates 32, AND gate 41 and Ex.OR gate 43. Seven-bit register 31 supplies a 7-bit parallel signal 36 to pattern generation section 37. Pattern generation section 37 produces a 15-bit parallel scramble signal (S1, S2 . . . S15) from 7-bit parallel input signal 36, wherein each of the 15 bits of the parallel scramble signal has a value identical with each of the scramble signal values to be successively supplied during the time from the first to the 15^{th} clock by the serial scramble circuit shown in FIG. 1.

Of the 15-bit parallel output signals S1-S15 ((8+7) parallel pattern), the output signals S1-S8 are employed for scramble processing of 8-bit parallel input signals 42 at Ex.OR gate 43. The output signals S9-S15 are fed back to the corresponding inputs of 7-bit register 31 and latched into the 7-bit register 31 in synchronization with clock signal 33.

Pattern generation section 37 provides the next scramble signal values to output bits S1-S15, wherein the scramble signal values are identical with the scramble signal values to be produced during the time from the 9th to 23rd clock by the serial scramble circuit shown in FIG. 1. Thereafter, an 8-bit parallel scramble signal is generated by repeating similar operations.

Pattern generation section 37 is a logic circuit that operates a predetermined combination of Ex.OR operations. It has an m-bit input and an (m+n)-bit output corresponding to the m^{th} order generator polynomial (as is shown in equation (1) in the case of m=7) as well as to the number of the parallel bits n. Pattern generation section 37 in the present example is made up of a combined-Ex.OR logic circuit having a 7-bit input and a 7+8 bit output.

Referring to FIG. 1, denoting the values of the Q outputs of flip-flop circuits 21, 22, 23, 24, 25, 26 and 27 by X7, X6, X5, X4, X3, X2 and X1, respectively, and also denoting the outputs of flip-flop circuit 27 provided in synchronization with each of 15 clocks by Y1, Y2 . . . Y15 yield the outputs of flip-flop circuit 27 as represented by the logic equations shown in FIG. 5. For this reason, defining the relations between the inputs X1-X7 and outputs Y1-Y15 of pattern generation section 37 as represented in FIG. 5 enables generation of scramble signal values for 15 clocks at a time.

OR gates 32 (cf. FIG. 3) are directed to initializing the Q-outputs of 7-bit register to “1111111” when initialization signal 34 is at logic 1. AND gate 41 is intended for an ON/OFF control of scramble processing: AND gate 41 blocks all of outputs S1-S8 from transmission when scramble control signal 40 is at logic 0, thereby allowing input data 42 to be transmitted without undergoing scramble processing at Ex.OR gate 43.

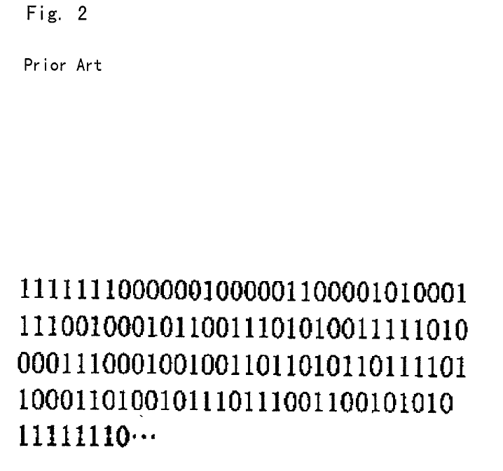

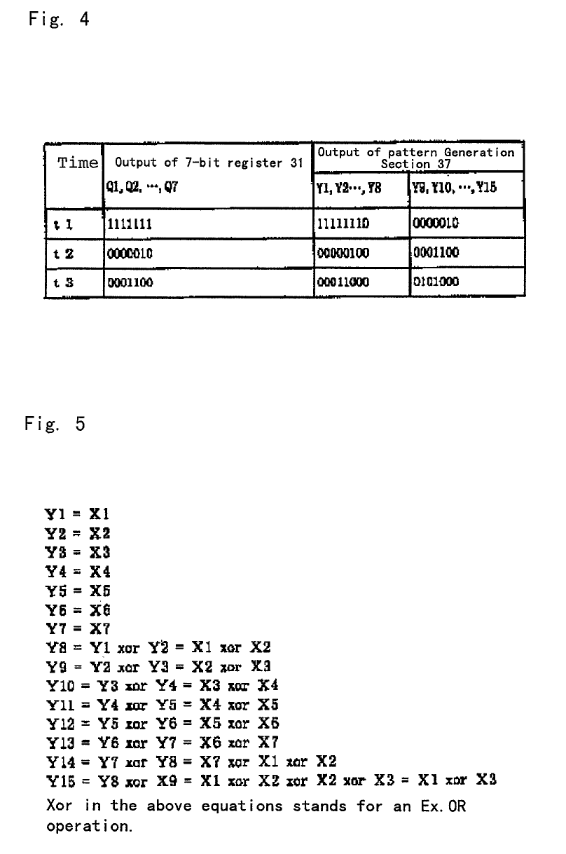

FIG. 4 represents a concrete example of an operation of the circuit shown in FIG. 3. At time t1, all the outputs of 7-bit register 31 are initialized to 1 by logic 1 of scramble initialization signal 34. On this occasion, the outputs of pattern generation section 37 Y1-Y15 can be obtained by substituting values of Q1-Q7 of 7-bit register 31 into X1-X7 shown in FIG. 5. The values of Y1-Y8 thus obtained serve as a scramble pattern. The outputs of Y9-Y15 are fed back to the corresponding inputs of 7-bit register 31 to produce the values Q1-Q7 of 7-bit register 31 at time t2. Repeating similar procedures yields the outputs Y1-Y8 of pattern generation section 37 shown in FIG. 4, which coincide with the values obtained by partitioning the scramble pattern shown in FIG. 2 in each 8 bits.

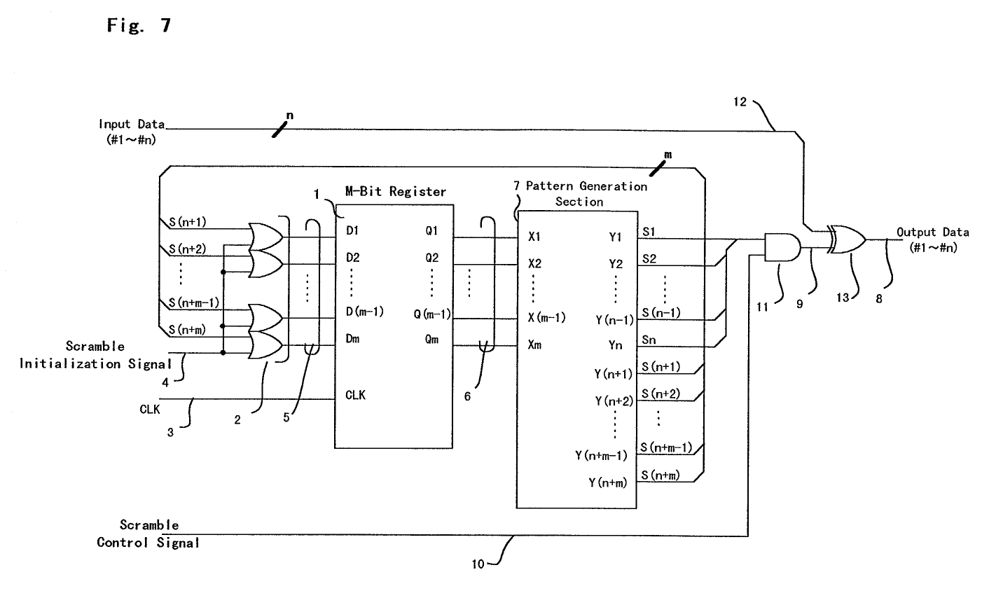

FIG. 7 represents a circuit diagram showing the configuration of the present invention in general terms, wherein the generator polynomial is X^{m}+X^{p}+1. The circuit includes m-bit register 1; pattern generation section 7 having m-bit inputs and (m+n)-bit outputs; AND gate 11 for an on/off control of scramble processing; Ex.OR gate 13 for exclusive-OR calculation of n-bit parallel input signal 12 and n-bit parallel scramble pattern 9; and OR gates 2 for initializing scramble procedures.

The pattern generation section 7 generates a parallel pattern by allotting the m input bits from X1 through Xm to the first m bits from Y1 through Ym of said parallel pattern as is and generates the following n bits from Y(m+1) through Y(m+n) in such a way that an Ex.OR of the bit i and the bit (i+1) makes the bit (m+i) of the parallel pattern. The first n bits of the (n+m)-bit parallel pattern are supplied as the n-bit parallel scramble pattern and the following m bits of the (n+m)bit parallel pattern are fed back through OR gates 2.

Since other constituents and signals are the same as those set forth with reference to FIG. 3, the explanation will be omitted.

When the present invention is applied to a scramble circuit of 512 parallel bits for signal processing in compliance with STM-64, for example, 19 MHz suffice for a scramble operation speed. The 19 MHz operation speed is sufficiently realizable by an ordinary CMOS-IC if the n-bit parallel random pattern generation circuit in accordance with the present invention is employed. In addition, since a generator polynomial as described in equation (1) can be applied to this case as well, the number of bits of the m-bit register 1 in FIG. 7 can be 7 bits regardless of the bit number of the n-bit parallel scramble pattern, thereby allowing the size of the circuit to be reduced.

Next, another embodiment will be presented. If scrambled data is supplied as input data 12 of FIG. 7, the circuit shown in FIG. 7 acts as a descramble circuit. Furthermore, the circuit made up of OR gates 2, m-bit register 1 and pattern generation section 7 of FIG. 7 can serve as an n-bit parallel pattern generating circuit for descrambling the scrambled data. It is to be noted that OR gates 2 of FIG. 7 can be replaced with a selector circuit and it is a matter of course that an arbitrary initial value can be supplied. AND gate 11 can be omitted depending on the way of use.

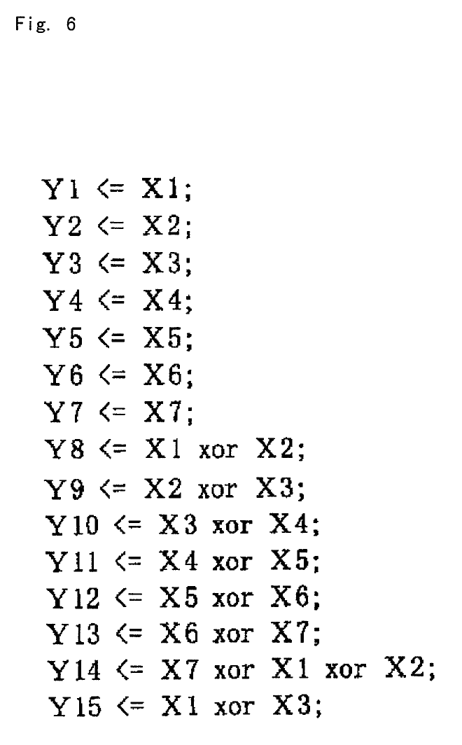

As described above, the present invention allows scramble processing to be effected by a parallel random pattern of a low operating speed. This further allows the n-bit random pattern generation circuit of the present invention is arranged in the apparatus that is required to effect a high speed operation, such as an SDH apparatus. The present invention allows the number of parallel scramble bits n to be arbitrarily selected within the scope of natural numbers, thereby enabling versatile applicability. Furthermore, the number of bits of the m-bit register depends only on the order of the generator polynomial. This allows the circuits of a large number of parallel bits to have a reduced circuit scale and a lower power expenditure. The m-bit register is a simple combination of Ex.ORs (XORS) as is shown in FIG. 5. Accordingly, FIG. 5, if rewritten to the format of FIG. 6, can be used as hardware description language as is. FIG. 6 serves to spare the designing time of the circuits.

It is to be understood, however, that although the characteristics and advantages of the present invention have been set forth in the foregoing description, the disclosure is illustrative only, and changes may be made in the shape, size, and arrangement of the parts within the scope of the appended claims.

What is claimed is:

1. An n-bit parallel random pattern generation circuit based on a generator polynomial X^{m}+X^{p}+1, wherein n is a natural number and m and p are natural numbers that satisfy an inequality m>p, comprising
an m-bit register having an m-bit input and an m-bit output,
a pattern generation means having an m-bit input and an (n+m)-bit output with the input bits 1 through m thereof connected with the output bits 1 through m, respectively, of said m-bit register, said pattern generation means operating an (n+m)-bit parallel pattern having bits 1 through n+m in accordance with a predetermined combination rule that defines a way of logically combining the individual m input bits thereof, and
feedback means for feeding-back the bits (n+1) through (n+m) of said (n+m)-bit parallel pattern to said m-bit input of said m-bit register
wherein the bits 1 through n of said (n+m)-bit parallel pattern are supplied as an n-bit parallel random pattern.

2. An n-bit random pattern generation circuit as claimed in claim 1, wherein said pattern generation means is provided with an exclusive OR means for generating a parallel pattern by allotting the m input bits 1 through m to the first m bits 1 through m of said parallel pattern as is and generating the following n bits (m+1) through (m+n) in such a way that an Ex.OR of the bit i and the bit (i+1) makes the bit (m+i) of said parallel pattern, and wherein said first n bits of said (n+m)-bit parallel pattern are supplied as said n-bit parallel random pattern and the following m bits of said (n+m)-bit parallel pattern are fed back by way of said feedback means.

3. A circuit as claimed in claim 2, wherein said feedback means includes OR gates for performing an OR operation of both an initialization signal for initializing said n-bit parallel random pattern generation circuit and each of the bits (n+1) through (n+m) of said (n+m)-bit parallel pattern.

4. An n-bit parallel scramble circuit for scrambling an n-bit parallel input by generating a scramble pattern based on a generator polynomial X^{m}+X^{p}+1, wherein n is a natural number and m and p are natural numbers that satisfy an inequality m>p, comprising
an m-bit register having an m-bit input and an m-bit output,
a pattern generation means having an m-bit input and an (n+m)-bit output with the input bits 1 through m thereof connected with the output bits 1 through m, respectively, of said m-bit register, said pattern generation means operating an (n+m)-bit parallel pattern having bits 1 through n+m in accordance with a predetermined combination rule that defines a way of logically combining the individual m input bits of said pattern generation means, and
feedback means for feeding-back the bits (n+1) through (n+m) of said (n+m)-bit parallel pattern to said m-bit input of said m-bit register
wherein the output bits 1 through n of said (n+m)-bit parallel pattern are supplied as an n-bit parallel scramble pattern.

5. An n-bit parallel scramble circuit as claimed in claim 4, wherein said pattern generation means is provided with a first exclusive OR means for generating a parallel pattern by allotting the m input bits 1 through m to the first m bits 1 through m of said parallel pattern as is, and generating the following n bits (m+1) through (m+n) in such a way that an Ex.OR of the bit i and the bit (i+1) makes the bit (m+i) of said parallel pattern, and wherein said first n bits of said (n+m)-bit parallel pattern are supplied as said n-bit parallel scramble pattern and the following m bits of said (n+m)bit parallel pattern are fed back by way of said feedback means.

6. A circuit as claimed in claim 5, wherein said feedback means includes OR gates for performing an OR operation of both an initialization signal for initializing said n-bit parallel random pattern generation circuit and each of the bits (n+1) through (n+m) of said (n+m)-bit parallel pattern.

7. A circuit as claimed in claim 6, further including a second exclusive OR circuit for performing an exclusive OR operation of said n-bit parallel scramble pattern and said n-bit parallel input, the output of said second exclusive OR circuit being supplied as an n-bit parallel scrambled output.

8. A circuit as claimed in claim 7, further including an on/off control means for controlling on/off of the scramble operation.

9. A circuit as claimed in claim 8, wherein said on/off control means is configured to control on/off of transmission of said n-bit parallel scramble pattern.

10. An n-bit parallel descramble circuit for descrambling an n-bit parallel scrambled input by generating a descramble pattern based on a generator polynomial X^{m}+X^{p}+1, wherein n is a natural number and m and p are natural numbers that satisfy an inequality m> p, comprising
an m-bit register having an m-bit input and an m-bit output,
a pattern generation means having an m-bit input and an (n+m)-bit output with the input bits 1 through m thereof connected with the output bits 1 through m, respectively, of said m-bit register, said pattern generation means operating an (n+m)-bit pattern having bits 1 through n+m in accordance with a predetermined combination rule that defines a way of logically combining the individual m input bits of said pattern generation means, and
feedback means for feeding-back the bits (n+1) through (n+m) of said (n+m)-bit parallel pattern to said m-bit input of said m-bit register
wherein the bits 1 through n of said (n+m)-bit parallel pattern are supplied as an n-bit parallel descramble pattern.
